(19) United States
(12) Patent Application Publication
(10) Pub. No.: US 2021/0028642 A1
(43) Pub. Date: Jan. 28, 2021

(54) ELECTRICAL ENERGY STORAGE SYSTEM AND METHOD FOR OPERATING SAME

(71) Applicant: Robert Bosch GmbH, Stuttgart (DE)

(72) Inventors: Arpad Imre, Vaihingen (DE); Herbert Schoenfelder, Asperg (DE)

(21) Appl. No.: 16/935,316

(22) Filed: Jul. 22, 2020

(30) Foreign Application Priority Data
Jul. 22, 2019 (DE) 10 2019 210 793.1

(51) Int. Cl. H02J 7/00

(52) U.S. Cl. CPC H02J 7/007182; H02J 7/0031; H02J 2207/20; H02J 7/0013; H02J 7/0047; H02J 7/007194

(57) ABSTRACT

Electrical energy storage system comprising a plurality of electrochemical energy storage units, which are electrically connectable by means of first switches to first terminal poles of the electrical energy storage system for providing a first electrical voltage; at least one second terminal pole for providing a second electrical voltage; at least one sensor for detecting a voltage variable representing an electrical voltage of one or more electrochemical energy storage units, and/or a temperature variable representing a temperature of one or more electrochemical energy storage units; at least one second switch, which is electrically connected to at least one of the electrochemical energy storage units, wherein, by means of the second switch, a pole of the at least one electrochemical energy storage unit is electrically connectable to the second terminal pole for providing the second electrical voltage, which is substantially equal to or less than the first electrical voltage, depending on the detected voltage variable and/or temperature variable.

### BRIEF DESCRIPTION OF THE DRAWINGS

The invention is based on an electrical energy storage system, a method for operating an electrical energy storage system and a use of the electrical energy storage system.

A generator and a 12 V lead acid battery are installed for the supply of electrical ancillary equipment in conventional vehicles. Said battery also supplies the emergency-relevant and legally prescribed consumers such as, for example, hazard warning lights system, airbag or warning indicator control unit of the vehicle. New hybrid and electric vehicles (mHEV, sHEV, PHEV) have installed in them, in addition to the lead acid battery, a more powerful battery and/or a battery having a higher capacity for drive purposes and recuperation processes. Said battery, often a lithium-ion battery, is usually dimensioned such that it is possible to supply emergency-relevant 12 V consumers and other consumers.

In contrast to lead acid batteries, the lithium-ion battery has a so-called battery disconnecting unit. Said disconnecting unit is able to disconnect the battery cells of the battery from connected consumers in the event of overcharging, overheating, short circuit and deep discharge, in order to protect the battery. The disconnection prevents outgassing, a fire or an explosion of the battery.

According to the prior art, the disconnecting device is configured such that in the event of a potential hazard, the power output with the electrical drive and also the consumers are completely electrically isolated from the battery. On account of this shutdown device, a supply of emergency-relevant consumers is not guaranteed. Therefore, an additional conventional 12 V battery is installed in present-day hybrid and electric vehicles.

The document DE 10 2013 204 238 A1 discloses a device for the stabilizing supply of a consumer from a buffer storage unit, said consumer being supplied from an energy storage unit during normal operation. The device comprises a DC/DC converter, a plurality of controllable switching elements and a control unit for controlling the switching state of the plurality of controllable switching elements depending on an input voltage of the device. The device is configured to supply the consumer directly from the energy storage unit during normal operation while bypassing components having a power loss if the input voltage is greater than a predefined first limit voltage, wherein the first limit voltage is a minimum voltage of the consumer for the supply thereof; to supply the consumer via the DC/DC converter fed from the energy storage unit if the input voltage falls below the first predefined limit voltage, wherein the DC/DC converter converts the input voltage to an operating voltage of the consumer; and to feed the DC/DC converter from the buffer storage unit if the input voltage falls below a second predefined limit voltage, until a voltage of the buffer storage unit reaches the second predefined limit voltage, wherein the second predefined limit voltage is a minimum voltage of the DC/DC converter for the operation thereof.

The document KR 10-1571110 discloses a portable emergency power supply device capable of charging a voltage for a short time from a discharged battery of a vehicle and supplying emergency power to the vehicle at the same time. The portable emergency power supply device comprises a first terminal, which is connected to an anode terminal of the discharged battery of the vehicle, a second terminal, which is connected to a cathode terminal of the discharged battery, and a connection to at least one high-capacitance storage device connected to the second terminal.

It is an object of the present invention to ensure a dependable supply of all emergency-relevant consumers from a high-energy battery and/or high-power battery and to further improve the prior art.

### SUMMARY OF THE INVENTION

To that end, the electrochemical energy storage system comprises:
a plurality of electrochemical energy storage units, which are electrically connectable by means of first switches to first terminal poles of the electrical energy storage system for providing a first electrical voltage;
at least one second terminal pole for providing a second electrical voltage;
at least one sensor for detecting a voltage variable representing an electrical voltage of one or more electrochemical energy storage units, and/or a temperature variable representing a temperature of one or more electrochemical energy storage units;
at least one second switch, which is electrically connected to at least one of the electrochemical energy storage units, wherein, by means of the second switch, a pole of the at least one electrochemical energy storage unit is electrically connectable to the second terminal pole for providing the second electrical voltage, which is substantially equal to or less than the first electrical voltage, depending on the detected voltage variable and/or temperature variable.

As a result, the electrical energy storage system has two “positive” electrical terminals and at least one common “negative” electrical terminal. The “positive” terminals can be electrically isolated by the first and second switches in each case individually from the pole of the at least one electrochemical energy storage unit. The at least second terminal pole is disconnected only at a higher temperature, a higher end-of-charge voltage and/or a lower end-of-discharge voltage of the at least one electrochemical energy storage unit in comparison with the first terminal poles. This ensures a dependable supply of all emergency-relevant consumers, in particular low-voltage consumers (<60 V DC), even in the case of a partial deep discharge, slight overheating and/or overcharging of the electrochemical energy storage system. Moreover, as a result, an additional traditional lead acid battery in the vehicle can be obviated, as a result of which a reduction of weight, structural space and costs is achieved.

An electrical energy storage system within the meaning of the present invention should be understood as an energy storage system having electrochemical energy storage units which can either have electrical energy drawn from them or can have electrical energy fed to them and drawn from them. An electrochemical energy storage unit is, in particular, a rechargeable battery or an accumulator. The electrochemical energy storage unit is advantageously a lithium-ion battery, a lithium-sulfur battery, a lithium-air battery and/or a battery having a solid electrolyte.

The electrochemical energy storage system furthermore comprises:
at least one first DC/DC converter, which is electrically connected to the second switch, wherein, by means of the second switch, the pole of the at least one electrochemical energy storage unit is electrically connectable to the DC/DC converter for providing the second electrical voltage at the second terminal pole, said second electrical voltage being lower than the first electrical voltage.

As a result, it is advantageously possible to ensure a supply of emergency-relevant consumers from an energy storage unit with a higher electrical voltage in comparison with the consumers.

The electrochemical energy storage system furthermore comprises:
at least one second DC/DC converter, which is electrically connected to at least one third switch, wherein the third switch is electrically connected to a pole of the at least one electrochemical energy storage unit and/or is electrically connectable to the second switch, wherein, by means of the third switch, the pole of the at least one electrochemical energy storage unit is electrically connectable to the second DC/DC converter for providing a third electrical voltage at a third terminal pole, said third electrical voltage being lower than the first electrical voltage.

As a result, it is advantageously possible to ensure a supply of different emergency-relevant consumers with different voltage levels from an energy storage unit.

A DC/DC converter should be understood to be, in particular, a bidirectional DC/DC converter. In accordance with one advantageous configuration of the invention, it is provided that the DC/DC converters can be embodied as flyback converters, as forward converters, push-pull converters, half-bridge converters, full-bridge converters and as resonance converters. The aforementioned converters are known DC/DC converters.

A switch should be understood to be, in particular, a relay and/or a semiconductor switch. In accordance with one advantageous embodiment, the switches can comprise power transistors, MOSFETs and/or thyristors.

The electrical voltage of each of the electrochemical energy storage units is in the range of 0.1 V≤X≤60 V, particularly preferably in the range of 2.8 V≤X≤4.2 V.

A method according to the invention for operating an electrical energy storage system according to any of the preceding claims, comprising the following steps:

a) detecting a voltage variable representing an electrical voltage of one or more electrochemical energy storage units, and/or a temperature variable representing a temperature of one or more electrochemical energy storage units;

b) comparing the detected voltage variable and/or the temperature variable with predefined threshold values;

c) driving the switches depending on the comparison.

The method according to the invention is not restricted to the presented order of the embodiment. Rather, steps a to c can be carried out repeatedly, temporally successively and/or at least partly simultaneously.

Driving the switches comprises opening the first switches if the detected voltage variable exceeds a threshold value U1,max, the detected temperature variable exceeds a threshold value T1,max and/or the detected voltage variable undershoots a threshold value U1,min.

Driving the switches comprises opening the second switches if the detected voltage variable exceeds a threshold value U2,max, the detected temperature variable exceeds a threshold value T2,max and/or the detected voltage variable undershoots a threshold value U2,min, wherein U1,max<U2,max, T1,max<T2,max and U1,min>U2,min.

Advantageously, an electrical energy storage system according to the invention finds use for electric vehicles, hybrid vehicles, plug-in hybrid vehicles, aircraft, pedelecs or e-bikes, for portable devices for telecommunications or data processing, for electrical handtools or kitchen appliances, and in stationary storage units for storing in particular regeneratively obtained electrical energy.

### BRIEF DESCRIPTION OF THE DRAWINGS

Exemplary embodiments of the invention are illustrated in the drawing and are explained in greater detail in the following description.

In the figures:

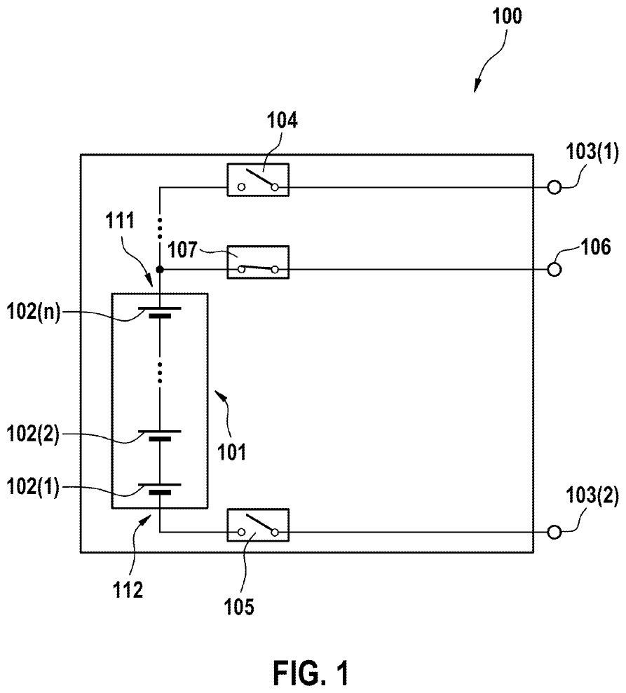

FIG. 1 shows a schematic illustration of a first embodiment of an energy storage system according to the invention; and

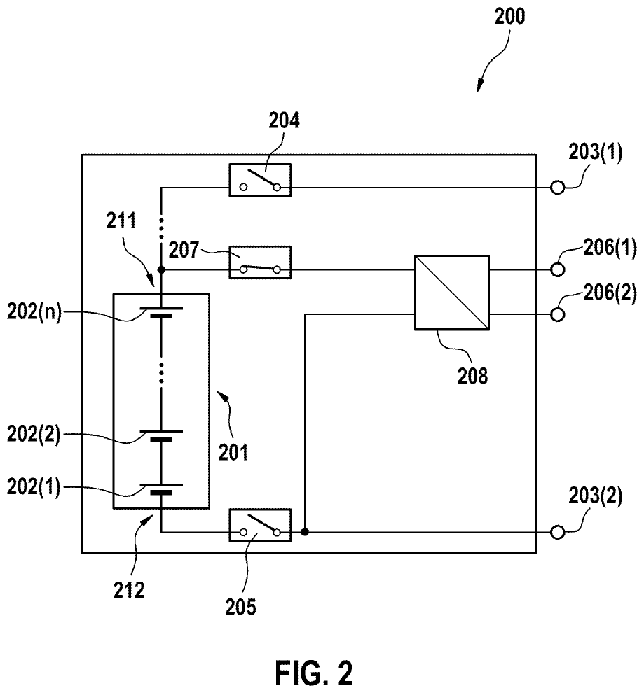

FIG. 2 shows a schematic illustration of a second embodiment of an energy storage system according to the invention;

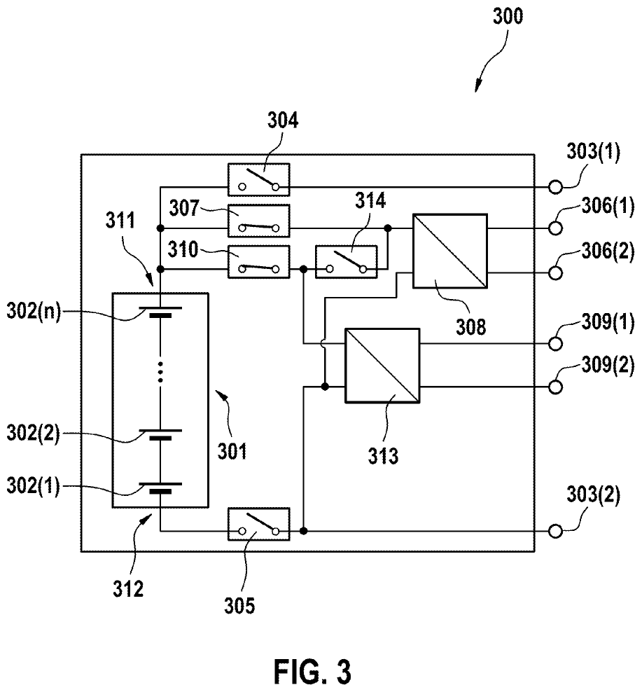

FIG. 3 shows a schematic illustration of a third embodiment of an energy storage system according to the invention.

### DETAILED DESCRIPTION

Identical reference signs designate identical device components in all the figures.

FIG. 1 shows a schematic illustration of a first embodiment of an energy storage system 100 according to the invention. The electrical energy storage system 100 comprises an electrochemical energy storage unit 101 having a plurality of electrochemical energy storage units 102(1), 102(2), 102(n) connected in series and also first terminal poles 103(1), 103(2) and a second terminal pole 106.

A first pole 111 of the electrochemical energy storage unit 101 is electrically connectable to the first terminal pole 103(1) by means of a first switch 104 and to the second terminal pole 106 by means of a second switch 107. A second pole 112 of the electrochemical energy storage unit 101 is electrically connectable to the first terminal pole 103(2) by means of a switch 105. As a result, it is possible to provide a first electrical voltage at the first terminal poles 103(1), 103(2) and a second electrical voltage at the second terminal pole 106.

In the embodiment shown, the electrical voltage provided at the first terminal poles 103(1), 103(2) is substantially identical to the second electrical voltage provided at the second terminal pole 106, for example 12 V or 48 V.

The electrical energy storage system 100 furthermore comprises at least one sensor for detecting a voltage variable representing an electrical voltage of one or more electrochemical energy storage units 102(1), 102(2), 102(n), and/or a temperature variable representing a temperature of one or more electrochemical energy storage units 102(1), 102(2), 102(n).

The first switch 104 is opened for example in the event of predefined threshold values being exceeded, for example in the event of a maximum electrical voltage U1,max and/or a maximum permissible temperature T1,max being exceeded, and/or in the event of a minimum electrical voltage U1,min being undershot.

The second switch 107 is opened for example in the event of predefined threshold values being exceeded, for example in the event of a maximum electrical voltage, U2,max and/or a maximum permissible temperature T2,max being exceeded, and/or in the event of a minimum electrical voltage U2,min being undershot, wherein the conditions U1,max<U2,max, T1,max<T2,max and U1,min>U2,min hold true for the threshold values.

FIG. 2 shows a schematic illustration of a second embodiment of an energy storage system 200 according to the invention. The electrical energy storage system 200 comprises an electrochemical energy storage unit 201 having a plurality of electrochemical energy storage units 202(1), 202(2), 202(n) connected in series and also first terminal poles 203(1), 203(2) and second terminal poles 206(1), 206(2).

A first pole 211 of the electrochemical energy storage unit 201 is electrically connectable to the first terminal pole 203(1) by means of a first switch 204. A second pole 212 of the electrochemical energy storage unit 201 is electrically connectable to the first terminal pole 203(2) by means of a switch 205. As a result, it is possible to provide a first electrical voltage at the first terminal poles 203(1), 203(2).

The first pole 211 of the electrochemical energy storage unit 201 is electrically connectable to a DC/DC converter 208 by means of a second switch 207, said DC/DC converter being electrically connected to the second terminal poles 206(1), 206(2). As a result, it is possible to provide a second electrical voltage at the second terminal poles 206(1), 206(2). The DC/DC converter 208 is a bidirectional DC/DC converter, for example. The performance of the DC/DC converter 208 limits a maximum output power of all emergency-relevant low-voltage consumers connected to the second terminal poles 206(1), 206(2).

In the embodiment shown, the second electrical voltage provided at the second terminal poles 206(1), 206(2), for example 12 V is lower than the first electrical voltage provided at the first terminal poles 203(1), 203(2), for example 48 V.

The electrical energy storage system 200 furthermore comprises at least one sensor for detecting a voltage variable representing an electrical voltage of one or more electrochemical energy storage units 202(1), 202(2), 202(n), and/or a temperature variable representing a temperature of one or more electrochemical energy storage units 202(1), 202(2), 202(n).

The first switch 204 is opened for example in the event of predefined threshold values being exceeded, for example in the event of a maximum electrical voltage U1,max and/or a maximum permissible temperature T1,max being exceeded, and/or in the event of a minimum electrical voltage U1,min being undershot.

The second switch 207 is opened for example in the event of predefined threshold values being exceeded, for example in the event of a maximum electrical voltage, U2,max and/or a maximum permissible temperature T2,max being exceeded, and/or in the event of a minimum electrical voltage U2,min being undershot, wherein the conditions U1,max<U2,max, T1,max<T2,max and U1,min>U2,min hold true for the threshold values.

FIG. 3 shows a schematic illustration of a third embodiment of an energy storage system 300 according to the invention. The electrical energy storage system 300 comprises an electrochemical energy storage unit 301 having a plurality of electrochemical energy storage units 302(1), 302(2), 302(n) connected in series and also first terminal poles 303(1), 303(2), second terminal poles 306(1), 306(2) and third terminal poles 309(1), 309(2).

A first pole 311 of the electrochemical energy storage unit 301 is electrically connectable to the first terminal pole 303(1) by means of a first switch 304. A second pole 312 of the electrochemical energy storage unit 301 is electrically connectable to the first terminal pole 303(2) by means of a switch 305. As a result, it is possible to provide a first electrical voltage at the first terminal poles 303(1), 303(2).

The first pole 311 of the electrochemical energy storage unit 301 is electrically connectable to a first DC/DC converter 308 by means of a second switch 307, said first DC/DC converter being electrically connected to the second terminal poles 306(1), 306(2). As a result, it is possible to provide a second electrical voltage at the second terminal poles 306(1), 306(2). The first DC/DC converter 308 is a bidirectional DC/DC converter, for example.

The first pole 311 of the electrochemical energy storage unit 301 is electrically connectable to a second DC/DC converter 313 by means of a third switch 310, said second DC/DC converter being electrically connected to the third terminal poles 309(1), 309(2). As a result, it is possible to provide a third electrical voltage at the third terminal poles 309(1), 309(2). The second DC/DC converter 313 is a bidirectional DC/DC converter, for example.

The DC/DC converters 308, 313 make it possible to ensure a supply of emergency-relevant consumers at a different voltage level at the additional second terminal poles 306(1), 306(2) and/or third terminal poles 309(1), 309(2).

In the embodiment shown, the third electrical voltage provided at the third terminal poles 309(1), 309(2), for example 12 V for a hazard warning lights systems, is lower than the second electrical voltage provided at the second terminal poles 306(1), 306(2), for example 48 V for safety functions and components for autonomous driving, and lower than the first electrical voltage provided at the first terminal poles 303(1), 303(2), for example 370 V for a traction drive.

The electrical energy storage system 300 furthermore comprises at least one sensor for detecting a voltage variable representing an electrical voltage of one or more electrochemical energy storage units 302(1), 302(2), 302(n), and/or a temperature variable representing a temperature of one or more electrochemical energy storage units 302(1), 302(2), 302(n).

The first switch 304 is opened for example in the event of predefined threshold values being exceeded, for example in the event of a maximum electrical voltage U1,max and/or a maximum permissible temperature T1,max being exceeded, and/or in the event of predefined threshold values being undershot, for example in the event of a minimum electrical voltage being undershot.

The second switch 307 is opened for example in the event of predefined threshold values being exceeded, for example in the event of a maximum electrical voltage, U2,max and/or a maximum permissible temperature T2,max being exceeded, and/or in the event of predefined threshold values being undershot, for example in the event of a minimum electrical voltage U2,min being undershot, wherein the conditions U1,max<U2,max, T1,max<T2,max and U1,min>U2,min hold true for the threshold values.

The third switch 310 is opened for example in the event of predefined threshold values being exceeded, for example in the event of a maximum electrical voltage U3,max and/or a maximum permissible temperature T3,max being exceeded, and/or in the event of predefined threshold values being undershot, for example in the event of a minimum electrical voltage U3,min being undershot, wherein the conditions U1,max<U2,max<U3,max, T1,max<T2,max<T3,max and U1,min>U2,min>U3,min hold true for the threshold values.

In the embodiment shown, the electrochemical energy storage system 300 comprises a further switch 314, which, with the second switch 307 having been opened and the third switch 310 having been opened, enables a shunt supply of the third terminals 309(1), 309(2) by the second terminals 306(1), 306(2) if a further current source is connected to the second terminals 306(1), 306(2).

1. An electrical energy storage system (100, 200, 300) comprising:
a plurality of electrochemical energy storage units (102(1), 102(2), 102(n), 201(1), 202(2), 202(n), 302(1), 302(2), 302(n)), which are electrically connectable by means of first switches (104) to first terminal poles (103(1), 103(2), 203(1), 203(2), 303(1), 303(2)) of the electrical energy storage system (100, 200, 300) for providing a first electrical voltage;
at least one second terminal pole (106, 206(1), 206(2), 306(1), 306(2)) for providing a second electrical voltage;
one or more sensors for detecting a voltage variable representing an electrical voltage of one or more electrochemical energy storage units (102(1), 102(2), 102(n), 201(1), 202(2), 202(n), 302(1), 302(2), 302(n)), a temperature variable representing a temperature of one or more electrochemical energy storage units (102(1), 102(2), 102(n), 201(1), 202(2), 202(n), 302(1), 302(2), 302(n)), or both;
a second switch (107, 207, 307), which is electrically connected to at least one of the electrochemical energy storage units (102(1), 102(2), 102(n), 201(1), 202(2), 202(n), 302(1), 302(2), 302(n)), wherein, by means of the second switch (107, 207, 307), a pole (111, 211, 311) of the at least one electrochemical energy storage unit (102(1), 102(2), 102(n), 201(1), 202(2), 202(n), 302(1), 302(2), 302(n)) is electrically connectable to the second terminal pole (106, 206(1), 206(2), 306(1), 306(2)) for providing the second electrical voltage, which is substantially equal to or less than the first electrical voltage, depending on the detected voltage variable, temperature variable, both.

2. An electrochemical energy storage system (100, 200, 300) according to claim 1, furthermore comprising:
at least one first DC/DC converter (208, 308), which is electrically connected to the second switch (207, 307), wherein, by means of the second switch (207, 307), the pole (211, 311) of the at least one electrochemical energy storage unit (102(1), 102(2), 102(n), 201(1), 202(2), 202(n), 302(1), 302(2), 302(n)) is electrically connectable to the DC/DC converter (208, 308) for providing the second electrical voltage at the second terminal pole (206(1), 206(2), 306(1), 306(2)), said second electrical voltage being lower than the first electrical voltage.

3. The electrochemical energy storage system (100, 200, 300) according to claim 2, furthermore comprising:
at least one second DC/DC converter (313), which is electrically connected to at least one third switch (310), wherein the third switch (310) is electrically connected to a pole (311) of the at least one electrochemical energy storage unit (102(1), 102(2), 102(n), 201(1), 202(2), 202(n), 302(1), 302(2), 302(n)), is electrically connectable to the second switch (307), or both, wherein, by means of the third switch (310), the pole (311) of the at least one electrochemical energy storage unit (102(1), 102(2), 102(n), 201(1), 202(2), 202(n), 302(1), 302(2), 302(n)) is electrically connectable to the second DC/DC converter (313) for providing a third electrical voltage at a third terminal pole (309(1), 309(2)), said third electrical voltage being lower than the first electrical voltage.

4. The electrochemical energy storage system (100, 200, 300) according to claim 1, wherein the DC/DC converter (207, 308, 313) is a bidirectional DC/DC converter.

5. The electrochemical energy storage system (100, 200, 300) according to claim 1, wherein the switches (104, 105, 107, 204, 205, 207, 304, 305, 307, 310, 314) are relays, semiconductor switches, or both.

6. The electrochemical energy storage system (100, 200, 300) according to claim 1, wherein the electrical voltage of each of the electrochemical energy storage units (102(1), 102(2), 102(n), 201(1), 202(2), 202(n), 302(1), 302(2), 302(n)) is in the range of 0.1 V ≤X ≤60 V.

7. A method for operating an electrical energy storage system (100, 200, 300) according to claim 1, comprising the following steps:
a) detecting a voltage variable representing an electrical voltage of one or more electrochemical energy storage units (102(1), 102(2), 102(n), 201(1), 202(2), 202(n), 302(1), 302(2), 302(n)), detecting a temperature variable representing a temperature of one or more electrochemical energy storage units (102(1), 102(2), 102(n), 201(1), 202(2), 202(n), 302(1), 302(2), 302(n)), or detecting both a variable representing an electrical voltage of one or more electrochemical energy storage units (102(1), 102(2), 102(n), 201(1), 202(2), 202(n), 302(1), 302(2), 302(n)) and a temperature variable representing a temperature of one or more electrochemical energy storage units (102(1), 102(2), 102(n), 201(1), 202(2), 202(n), 302(1), 302(2), 302(n));
b) comparing the detected voltage variable, the temperature variable, or both with predefined threshold values (U1,max; T1,max; U1,min; U2,max; T2,max; U2,max); and
c) driving the switches (104, 105, 107, 204, 205, 207, 304, 305, 307, 310, 314) depending on the comparison.

8. The method for operating an electrical energy storage system (100, 200, 300) according to claim 7, wherein the driving comprises opening the first switches (104, 204, 304) if the detected voltage variable exceeds a threshold value U1,max, the detected temperature variable exceeds a threshold value T1,max, the detected voltage variable undershoots a threshold value U1,min, or a combination of the same.

9. The method for operating an electrical energy storage system (100, 200, 300) according to claim 7, wherein the driving comprises opening the second switches (107, 207, 307) if the detected voltage variable exceeds a threshold value U2,max, the detected temperature variable exceeds a threshold value T2,max, the detected voltage variable undershoots a threshold value U2,min, or a combination of the same, wherein U1,max<U2,max, T1,max<T2,max and U1,min>U2,min.
